(19) United States
(12) Patent Application Publication
(10) Pub. No.: US 2013/0167436 A1
(43) Pub. Date: Jul. 4, 2013

(54) Row Planting Propagation Device Comprising Tubular Casing Divided into Pouches, and Method for Producing Same

(71) Applicant: Todd B. Chornoby, Winnipeg (CA)

(72) Inventor: Todd B. Chornoby, Winnipeg (CA)

(21) Appl. No.: 13/684,309

(22) Filed: Nov. 23, 2012

Related U.S. Application Data
(60) Provisional application No. 61/576,633, filed on Dec. 16, 2011.

(51) Int. Cl. A01C 1/04; B65B 1/04

(52) U.S. Cl. CPC A01C 1/042; B65B 1/04
USPC 47/56; 141/1

(57) ABSTRACT

A plant propagating device for propagating plants in one or more rows features a flexible, biodegradable, tubular casing having a longitudinal axis, and a plurality of deposits disposed at spaced apart intervals along the longitudinal axis of the tubular casing, each deposit comprising plant propagation material and at least one of fertilizer and soil. The tubular casing is fastened closed between each adjacent pair of the deposits to separate the deposits into respective pouches spaced along the longitudinal axis of the casing.

### CROSS REFERENCE TO RELATED APPLICATIONS

This application claims benefit under 35 U.S.C. 119(e) of U.S. Provisional Patent Application Ser. No. 61/576,633, filed Dec. 16, 2012, the entirety of which is incorporated herein by reference.

### FIELD OF THE INVENTION

The present invention relates to elongated plant propagation devices having seeds or other propagation material disposed therealong for propagating plants in rows, and more particularly a device and production method in which the seeds or propagation material are deposited into a tubular casing that is divided up along its length to form separate planting pouches spaced therealong.

### BACKGROUND OF THE INVENTION

In the fields of horticulture and agriculture, there are a number of previous publications concerning the use of seed tape or similar elongated articles carrying seeds for seeding of plants in rows.

Prior patent documents concerning various seed carriers of this and other types include U.S. Pat. Nos. 2,571,491, 2,812,618, 2,976,646, 3,328,916, 3,456,386, 3,754,643, 4,780,988, 5,165,351, 6,088,957, 7,452,165; U.S. Patent Application Publications 2005/0236315 and 2008/0016759; and Chinese Patent Publication Number 100998278 (Application Number 200610135042).

Applicant has developed a new seeding device and seeding device fabrication method including unique features not found or suggested in the above prior art.

### SUMMARY OF THE INVENTION

According to a first aspect of the invention there is provided a plant propagating device for propagating plants in one or more rows, the device comprising:

a flexible, biodegradable, tubular casing having a longitudinal axis;

a plurality of deposits disposed at spaced apart intervals along the longitudinal axis of the tubular casing, each deposit comprising plant propagation material and at least one of fertilizer and soil;

wherein the tubular casing is closed off between each adjacent pair of the deposits to separate the deposits into respective pouches spaced along the longitudinal axis of the casing.

According to a second aspect of the invention there is provided a method of producing a plant propagating device for propagating plants in one or more rows, the method comprising:

providing a flexible, biodegradable, tubular casing having a longitudinal axis;

providing a plurality of deposits each comprising plant propagation material and at least one of fertilizer and soil;

inverting a first portion of the tubular casing at a first end thereof into an inside out condition to dispose the first end of the tubular casing inside an uninverted remainder of the tubular casing extending along the longitudinal axis toward an opposite second end of the tubular casing, and positioning a first one of the deposits in the first inverted portion of the tubular casing; and

for each additional deposit of the plurality of deposits, inverting a respective further portion of the tubular casing into the inside out condition to lie adjacent the last inverted portion to a side thereof opposite the first end of the tubular casing along the longitudinal axis, and positioning the additional deposit in the respective inverted portion of the tubular casing.

### BRIEF DESCRIPTION OF THE DRAWINGS

In the accompanying drawings, which illustrate exemplary embodiments of the present invention:

FIG. 1 is a schematic sectional view of a garden rope seeding product of the present invention.

FIG. 2 is a schematic illustration of the garden rope seeding product coiled on a rotating spool for convenient deployment and measurement of a customer selected length of garden rope.

FIGS. 3A-3E are schematic sectional views illustrating a sequence of steps in production of the garden rope product of FIG. 1.

### DETAILED DESCRIPTION

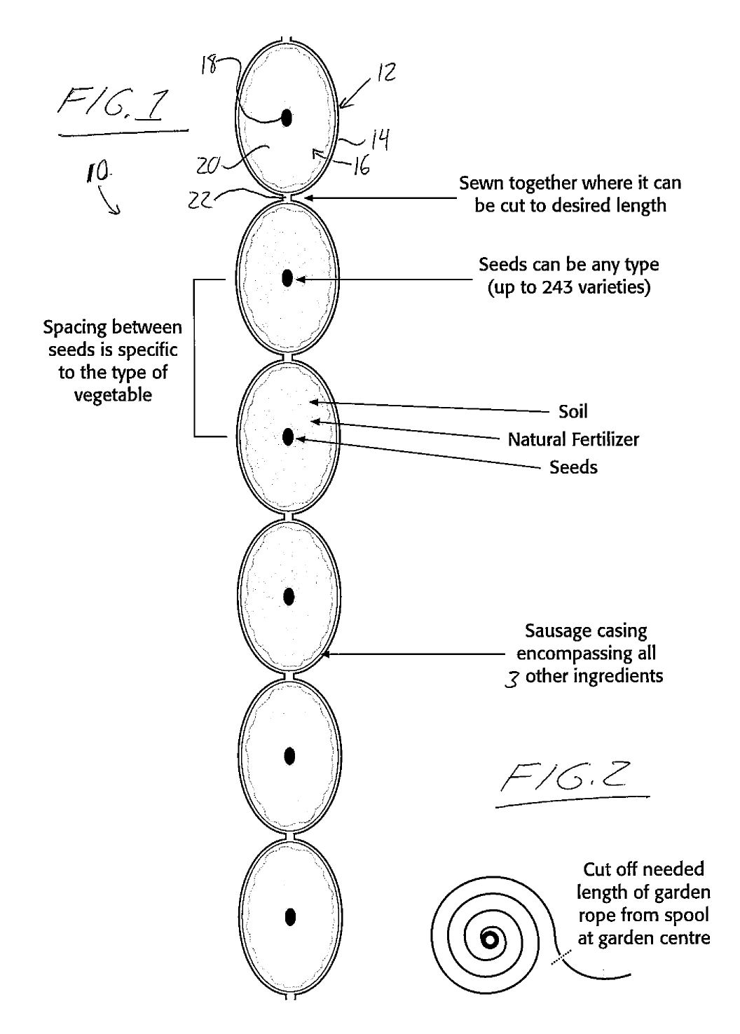

FIG. 1 shows a seeding device 10 for seeding of plants in one or more rows, for example in a home or commercial garden. The device 10 is in the form of an elongate, flexible member 12 divided into a plurality of spaced-apart pouches disposed along its longitudinal axis. The device is thus similar in shape to a beaded rope or string, and thus may be referred to as a garden rope, or seed rope. While similar in end-use, the structure differs from prior ‘seed tape’ devices where the elongate shape on which seeds are carried at spaced positions over its length is defined by flat, narrow strips or ribbons of tape.

The device 10 features a tubular casing 14 defining its overall elongate shape and flexible structure. The tubular casing 14 is formed of a biodegradable material, for example a cloth made from fibres of hemp, manilla hemp, cotton, coir, jute, sisal, or other suitable material. The casing is filled at spaced apart locations therealong with discrete deposits 16, each comprising a seed 18 embedded within a surrounding cohesive body 20 formed from a mixture of soil and fertilizer. Between each pair of adjacent deposits, the tubular casing 14 is pinched or twisted into a closed condition, as shown generally at 22, and fastened in this closed condition to secure this closure between the two seed deposits 16. Pinched or twisted into a collapsed state closing off its hollow interior at either end of each deposit 16, the tubular casing 14 thus reduces in outer diameter on either side of the deposit 16, acting like a sausage casing to contain the material of each deposit within it, for carrying of the deposits together as a single collective unit, like connected links of sausage.

At the collapsed small diameter connections 22 between the deposits 16, the casing 14 is preferably sewn, glued or otherwise fastened into this closed condition acting to separate the materials of one deposit from the next. Each seed deposit is thus effectively retained in its own dedicated pouch, closed off at either end of the deposit along the longitudinal axis of the casing.

The preferred embodiment employs a natural organic fertilizer, for example manure, which not only serves to provide nutrients useful to the seed for propagation of the plant, but also acts hold the soil together in a cohesive body surrounding the seed. By including both fertilizer and soil, the preferred embodiment not only adds to the nutrient level of the earth in which the device is deposited, but additionally can be used to upgrade the growing conditions where the existing soil make-up condition in the earth is less than ideal by providing its own source of soil.

The seeds 18 of the device are spaced apart along the length of the device by an equal distance from one to the next, the appropriate distance being selected on the basis of the type of seed, according to known optimized seed spacing for different plant types. The product is used in a similar manner to prior art seed tapes, by forming a furrow of suitable depth for the plant being grown, laying the garden rope along the bottom of the furrow, back filling the top of the furrow over the garden rope to burrow the seeds at the suitable depth. The plants propagating from the seeds will emerge at spaced apart locations according to the predetermined spacing of the seeds along the garden rope.

Having a rope-like form, the device 10 can be coiled onto a rotatable spool or reel, as schematically illustrated in FIG. 2, so that a consumer at a garden center or other provider of seeds and related gardening products may uncoil a desired length of the garden rope from the spool or reel through rotation thereof in the appropriate direction feeding the free end of the garden rope from the spool or reel, and cut off this selected length of garden rope.

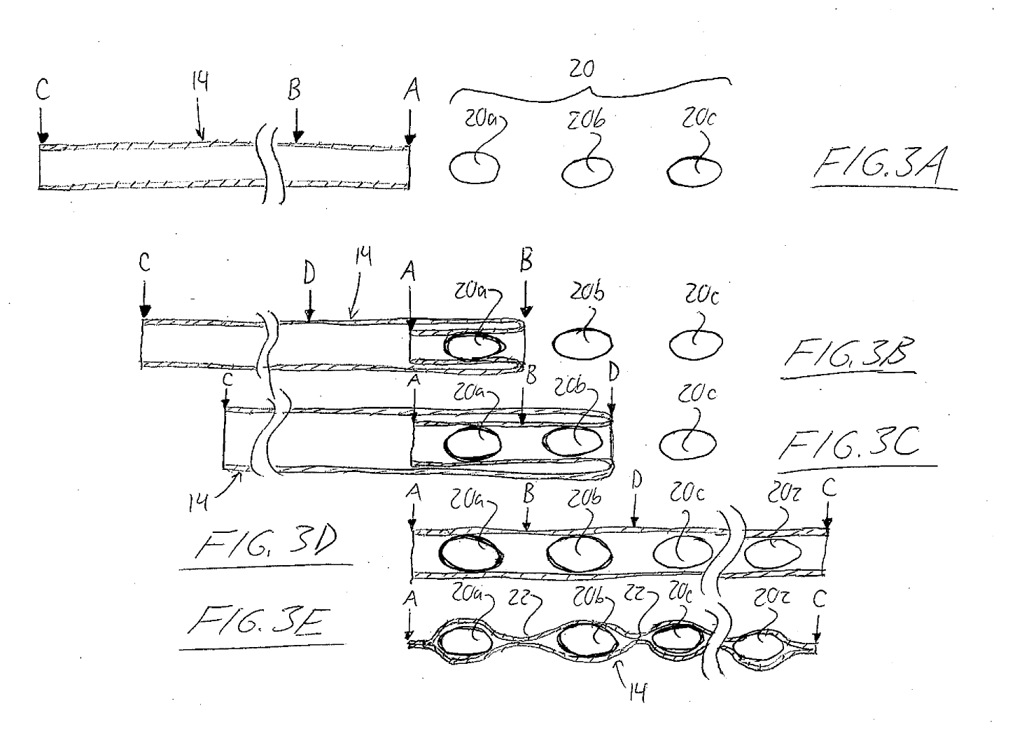

Turning now to FIG. 3 of the drawings, a method of production of the garden rope product of FIG. 1 is described as follows.

Referring to FIG. 3A, first a series of seed deposits 20 are laid out one after the other in a line starting from near one end A of the initially empty hollow tubular casing 14, and moving away therefrom. Each deposit consists of a mixture of soil and manure rolled into a cohesive body in which the seed is embedded, preferably at a center of the surrounding body. In the illustrated embodiment, these cohesive bodies are shown to be preformed with an oval-, ellipse-, or egg-like shape elongated in the direction of the tubular casing's longitudinal axis, but it will be appreciated that the deposits may alternatively take on other shapes, including but not limited to round balls.

Referring to FIG. 3B, the wall of the flexible tubular casing 14 is externally gripped at a point B located at an axial distance from the casing's first end A toward the casing's second opposing end C, this distance exceeding the length of the first seed deposit 20a located nearest the end A of the tubular casing 14 (the length of the seed deposit referring to its measurement along the tubular casing's longitudinal axis). The circumference of the tubular casing 14 at Point B is pulled along the longitudinal axis of the tubular casing toward, and subsequently past, the casing's first end A, pulling the remainder of the tubular casing on the opposite side of Point B with it, as shown by the displacement of casing's second end C toward the first end A in the transition from FIG. 3A to 3B. Doing this acts to invert the portion of the tubular casing between Points A and B into an inside-out condition relative to its initial condition, so that portion A-B now resides inside the uninverted remainder B-C of the casing. The first seed deposit 20a is placed inside the inverted portion A-B of the tubular casing, either by performing this inverting process of the first end of the casing over the first seed deposit 20a (by pulling Point B over and fully past the seed deposit 20a during the inversion process), or by placing the first seed deposit inside the tubular casing adjacent the first end A thereof after the inversion of this end portion A-B.

Turning to FIG. 3C, this inverting process is then repeated for a subsequent portion of the as-yet uninverted remainder of the tubular casing in order to dispose the second seed deposit 20b inside the tubular casing near, but spaced from, the first seed deposit 20a. That is, the circumference of the tubular casing 14 at Point D is pulled along the longitudinal axis of the tubular casing toward, and subsequently past, both the casing's first end A and Point B at the casing's new effective outer end, thereby pulling the remainder of the tubular casing on the opposite side of Point D with it, as shown by the displacement of casing's second end C toward the first end A in the transition from FIG. 3B to 3C. Doing this acts to invert the portion of the tubular casing between Points B and D into an inside-out condition relative to its initial condition, so that portion B-D now resides inside the uninverted remainder D-C of the casing adjacent the first inverted portion A-B. The second seed deposit 20b is placed inside the second inverted portion B-D of the tubular casing, again either during or after the inversion process.

Turning to FIG. 3D, this inversion process is repeated for the additional portions of the tubular casing 14 until a last seed deposit 20z in the series is disposed inside the tubular casing, or until the entire casing 14 has been inverted to an inside-out condition relative to its original state. In the illustrated embodiment, these two events occur simultaneously, as the number of seed deposits has been selected together with the appropriate inter-seed spacing in order to use the full length of the tubular casing, thereby placing the second end C of the casing just past the final seed deposit 20z after placement thereof in the last-inverted portion of the casing 14. That is, the last inversion step involves pulling second end C externally over and past the effective end of casing where it turns back through itself from adjacent the last-inserted seed deposit.

As shown in FIG. 3E, the illustrated production process is completed in a final step by pinching or twisting the tubular casing 14 closed at the locations 22 between each pair of adjacent seed deposits therein and securing the casing 14 in this closed condition at each inter-deposit location 22, for example by sewing, adhesive fastening or a combination thereof. This separates the seed deposits into separate pouches each defined between two adjacent closure locations 22 of the tubular casing 14. The tubular casing 14 is likewise closed off in this manner at each of its opposing ends A, C.

While the above embodiment is defined in terms of pre-formed deposits having a cohesive shape-retaining form, and closure of the seed deposit pockets after placement of all seed deposits in the tubular casing, it will be appreciated that other embodiments may employ an initial closure of the first end A of the casing 14, placement of a cohesive mass or loose deposit of seed, fertilizer and soil after each casing-inversion step, and closure of the casing after each deposit placement after packing thereof into the casing against the last closure. Where loose material is used, the cloth, fabric, weave, mesh or other structure of the tubular casing should be sufficiently closed to prevent significant loss of the seed deposit material through the wall of the casing, especially the seed itself.

While described in terms of seed, it will be appreciated that the invention may employ alternative plant propagation material according to the plant intended to grow, for example including bulbs, corms, tubers, eyes, and vegetative propagation elements. While the preferred embodiment employs both soil and fertilizer in each seed deposit, alternative embodiments may employ only one or the other.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A plant propagating device for propagating plants in one or more rows, the device comprising:
a flexible, biodegradable, tubular casing having a longitudinal axis;
a plurality of deposits disposed at spaced apart intervals along the longitudinal axis of the tubular casing, each deposit comprising plant propagation material and at least one of fertilizer and soil;
wherein the tubular casing is fastened closed between each adjacent pair of the deposits to separate the deposits into respective pouches spaced along the longitudinal axis of the casing.

2. The plant propagating device of claim 1 where each deposit comprises soil.

3. The plant propagating device of claim 1 where each deposit comprises fertilizer.

4. The plant propagating device of claim 1 wherein the tubular casing is sewn closed between each adjacent pair of the deposits.

5. The plant propagating device of claim 1 wherein the tubular casing is adhesively closed off between each adjacent pair of the deposits.

6. The plant propagating device of claim 1 wherein each deposit comprises a cohesive mass in which the plant propagation material is embedded within surrounding material.

7. The plant propagating device of claim 6 wherein the plant propagation material is centered within the cohesive mass.

8. The plant propagating device of claim 6 wherein the cohesive mass is ball-shaped.

9. The plant propagating device of claim 1 wherein the tubular casing is stored in a coiled fashion.

10. The plant propagating device of claim 9 wherein the tubular casing is coiled on a rotatably supported spool for feeding off the tubular casing from the spool under rotation thereof in a predetermined direction.

11. A method of producing a plant propagating device for propagating plants in one or more rows, the method comprising:
providing a flexible, biodegradable, tubular casing having a longitudinal axis;
providing a plurality of deposits each comprising plant propagation material and at least one of fertilizer and soil;
inverting a first portion of the tubular casing at a first end thereof into an inside out condition to dispose the first end of the tubular casing inside an uninverted remainder of the tubular casing extending along the longitudinal axis toward an opposite second end of the tubular casing, and positioning a first one of the deposits in the first inverted portion of the tubular casing; and
for each additional deposit of the plurality of deposits, inverting a respective further portion of the tubular casing into the inside out condition to lie adjacent the last inverted portion to a side thereof opposite the first end of the tubular casing along the longitudinal axis, and positioning the additional deposit in the respective inverted portion of the tubular casing.

12. The method according to claim 11 comprising fastening the tubular casing closed at locations along the longitudinal axis between adjacent pairs of the deposits in the tubular casing to separate the deposits into respective pouches spaced along the longitudinal axis of the casing.

13. The method according to claim 11 comprising fastening the tubular casing closed at locations along the longitudinal axis before and after each deposit in the tubular casing to separate the deposits into respective pouches spaced along the longitudinal axis of the casing.

14. The method according to claim 12 comprising sewing the tubular casing at the positions along the longitudinal axis of the tubular casing.

15. The method according to claim 12 comprising applying adhesive at the positions along the longitudinal axis of the tubular casing.

16. The method according to claim 11 comprising forming each deposit as a cohesive mass in which the plant propagation material is embedded.

17. The method according to claim 16 comprising embedding the plant propagation material of each deposit centrally within the cohesive mass thereof.

18. The method according to claim 16 comprising shaping each cohesive mass into a ball.

19. The method according to claim 11 wherein each deposit comprises soil.

20. The method according to claim 11 wherein each deposit comprises fertilizer.
